(19) United States
(12) Patent Application Publication
(10) Pub. No.: US 2013/0254689 A1
(43) Pub. Date: Sep. 26, 2013

(54) Wayfinding System and Method

(71) Applicant: Jeff Clift, New York, NY (US)

(72) Inventor: Jeff Clift, New York, NY (US)

(73) Assignee: Creative Realities, LLC, Fairfield, NJ (US)

(21) Appl. No.: 13/600,042

(22) Filed: Aug. 30, 2012

Related U.S. Application Data
(60) Provisional application No. 61/529,488, filed on Aug. 31, 2011.

(51) Int. Cl. G06F 3/0481

(52) U.S. Cl. CPC G06F 3/0481
USPC 715/765

(57) ABSTRACT

A method and system of providing information is provided. The system for providing information includes a display screen with a user interface, an input device operatively connected to the display screen, a processor, and a memory containing processor-executable instructions that cause the system to receive an input from the input device. A relative position on the display screen is determined to display user content based on the position of received input and the user content is displayed at the determined relative position.

This application claims priority from U.S. Provisional Patent Application No. 61/529,488, filed on Aug. 31, 2011, entitled WAYFINDING SYSTEM AND METHOD, which application is incorporated by reference in its entirety.

### FIELD OF THE INVENTION

The subject technology relates generally to a method and system for providing information. More particularly, the invention relates to a computer-implemented method and system for providing information via a user interface, including adjusting the position of a menu in the user interface on a touch screen display.

### DESCRIPTION OF THE RELATED ART

Existing systems allow users to interact with a device in order to browse available content such as maps and business directory information. Such systems may allow users to access maps and related information by interacting with a keyboard, screen, or other input devices.

The subject technology seeks to advance the art by addressing the limitations of existing systems by providing a more personalized interaction of user interfaces for such systems. The invention further seeks to provide a more comfortable and accessible user experience for a wide variety of potential users.

### SUMMARY OF THE INVENTION

A system for providing information includes a display screen having a user interface, an input device operatively connected to the display screen, a processor configured to receive inputs from the input device, and a memory containing processor-executable instructions that, when executed by the processor, cause the system to receive an input from the input device. The system further determines a relative position on the display screen at which to display user content based on the position of received input and displays the user content at the determined relative position.

A method of providing information is also provided. The method comprises displaying a menu on a user interface of a touch-screen display and receiving input from the touch-screen display. The method further includes determining a position of the received input on the touch-screen display, determining a relative position of a menu of the user interface based on the position of the received input, and adjusting the position of the menu on the user interface of the touch-screen display to display the menu at the determined relative position.

A system for providing information is also provided including a touch-screen display, a processor, and a memory containing processor-executable instructions that, when executed by the processor, cause the system to display a menu on the user interface of the touch-screen display. The system also receives input from the touch-screen display, determines a position of the input on the touch-screen display, and adjusts the relative position of the menu in the user interface of the touch-screen display based on the position of received input. The system also displays a coupon associated with a business including an electronically readable code.

### BRIEF DESCRIPTION OF THE DRAWINGS

Various embodiments of the disclosure are now described, by way of example only, with reference to the accompanying figures.

FIG. 1 is a block diagram illustrating an implementation of the system in accordance with the subject technology.

FIG. 2 illustrates an example process for providing information in accordance with the subject technology.

FIG. 3 illustrates a system and a method of interacting with wayfinder device as in FIG. 1 in accordance with the subject technology.

FIG. 4 illustrates one example of a menu on a touch-screen display for providing information in accordance with the subject technology.

FIG. 5 is a series of display screen shots illustrating how a user can initiate and interact with a menu in accordance with the subject technology.

FIG. 6 is a series of display screen shots illustrating a process by which a user can identify businesses and locate discounts in accordance with the subject technology.

FIG. 7 is a series of display screen shots illustrating one example of the search functionality in accordance with one implementation of the subject technology.

FIG. 8 illustrates an example of a series of recommended results that may be provided in accordance with the subject technology in the event that a search using the wayfinder device fails.

FIG. 9 illustrates an exemplary system and method for providing a map interface in accordance with the subject technology for a series of interfaces enabling a user to browse a map.

FIG. 10 illustrates an exemplary system and method for providing incentives in accordance with the subject technology.

FIG. 11 illustrates an exemplary system and method for providing emergency assistance in accordance with the subject technology.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those of ordinary skill in the art will understand that such specificity with respect to sequence is not actually required. It will be appreciated that certain elements, including, but not limited to, display screens and menus may be described or depicted with a particular vertical or horizontal orientation while those of ordinary skill in the art will understand that such specificity with respect to orientation is not actually required. It will also be understood that the terms and expressions with respect to their corresponding respective areas of inquiry and study except where specific meaning have otherwise been set forth herein.

### DETAILED DESCRIPTION OF THE INVENTION

The subject technology provides a novel wayfinder system that may be used in public or private areas, such as shopping malls, airports, parks, hospitals, etc., to aid users in navigating and identifying points of interest. A user may interact with a wayfinder device of the wayfinder system through the use of a touch-screen display in order to obtain the user's current location, the location of nearby restaurants, restrooms, businesses within the area, and the like. The user may further obtain maps and or routes to locations, areas, or items of interest. The user may also obtain information related to the map, venue, and related products and services. Examples of services include, but are not limited to, information regarding handicapped accessibility, first aid stations, information booths, security assistance, sales promotions, events, and the like.

Marketing and promotional information such as, but not limited to, advertisements, sales, or special events may be displayed to the user at any point in time during the user's interaction with the user interface. Specific promotional information, such as a coupon or other incentive may be provided to the user. The types of coupons and incentives provided to the user may be based on the user's input and interaction with the wayfinder system. The user may obtain a coupon or other incentive for use at the point of sale by electing to receive text messages or other electronic messages containing information regarding the promotional information. Coupons or other incentives may be displayed or otherwise made available to the user as a barcode, QR code, or other electronically readable code. When the code is displayed on the screen, the user may capture the image of the code using a personal user device such as a camera, a smart phone, or other mobile device. The captured image may then be shown at the point of sale for scanning and entering of the coupon or incentive by the corresponding business. The user may obtain or access content and information with the wayfinder system by interacting with a menu-based user interface on the touch-screen display of the wayfinder device. The user may tap, swipe, scroll, search, type, select, and otherwise interact with the user interface, using gestures commonly used with interactive touch-screens, and/or as would be understood by those of ordinary skill in the art having the present disclosure before them.

The user's menu-based and gestural interactions with the wayfinder device may be personalized by locating content and/or menus in the user interface at a position on the touch-screen display that is based on the position of the user's initial touch of the screen. The term “menu” as used herein encompasses content to be displayed to a user including a master or other navigational menu and any other interactive content that can be displayed on all or a portion of a display screen providing information. A menu may include one or more of images, video, audio, text, interactive icons, a virtual keyboard, other audio-visual content and the like. Interaction with a menu may lead to the display of additional menus or content, which may be considered as portions of the menu. A single menu may include multiple variations of the display, position of content, and information and may be predetermined or may be dynamically customized during user interaction. A menu may include any type of content or information that assists the user in initiating or continuing browsing or searching through menus, content, and information accessible through the subject technology, as would be understood by those of ordinary skill in the art having the present disclosure before them. Subsequent menu screens including menu screens with virtual keyboards may also be positioned at or near the location of the menu on the touch-screen display in order to provide a comfortable position for the user to interact with the wayfinder system. For example, a very tall person may choose to interact with menus near the top portion of the touch-screen display, and young children or seated users (such as in a wheelchair) may interact with menus near the bottom portion of the touch-screen display.

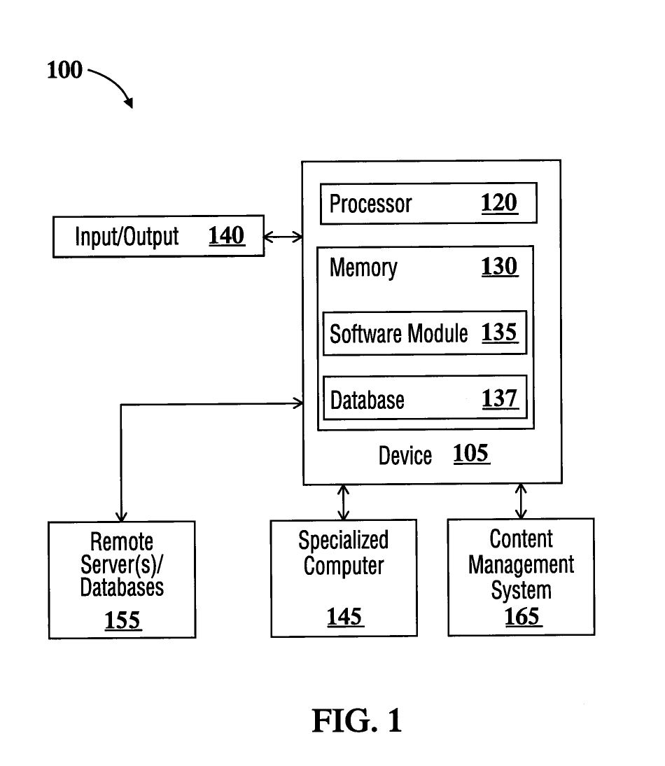

FIG. 1 is a block diagram illustrating an implementation of the system 100 in accordance with the subject technology. The wayfinder system 100 can include one or more wayfinder devices 105 (also referred to as simply a “device”), one or more remote servers and databases 155, one or more specialized computers 145, one or more content management systems 165, all of which are operatively connected to one another, either directly or indirectly, as would be understood by those of ordinary skill in the art having the present disclosure before them. These components of the system 100 may be connect through a wired or wireless network as known in the art. The device 105 may be, by way of example, a desktop computer, a laptop computer, or any other computing device with a processor, memory, and communications capabilities. The device 105 may include a housing to conveniently provide access to input/output devices 140 to users. In one implementation, the housing may allow a provider to prevent user access to other portions of the wayfinder device 105. as would be understood by those of ordinary skill in the art having the present disclosure before them. Device 105 includes one or more processors 120 capable of executing instructions that are either physically coded into the processor 120 and/or provided from a software module 135 in memory 130. Memory 130 may be housed locally in the device 105, accessed remotely from a remote server 155, accessed from a content management system 150, or accessed from any combination of the foregoing locations, as would be understood by those of ordinary skill in the art having the present disclosure before them. Stored instructions may allow device 105 to provide information to a user via input/output device 140. Memory 130 further includes a software module 135 which may store instructions for execution by processor 120. Such instructions as executed by the processor 120 allow the wayfinder device 105 to provide information for display and allow the user to conduct searches of information stored in database 137 of memory 130 or elsewhere (as would be understood by those of ordinary skill in the art having the present disclosure before them) and otherwise allow the user to navigate through the menus and other content. Information and content stored in memory 130 and/or in the content management system 165 or remote databases 155, may include various content including, for example, maps, locations, walking routes, event information, services information, product information, promotional information such as advertisements, coupons, or other incentives, and any other business-related information. Information may be provided to and received from an input/output device 140 that is operably connected with device 105, and instructions from software module 135 executed by processor 120 may provide information (such as for example, maps, locations, walking routes, event information, services information, product information, promotional information such as advertisements, coupons, or other incentives, and any other business-related information) for output via input/output device 140.

Input/output device 140 provides the user interface for a user to interact with the device 105 and may consist of a touch-screen display, display with stylus, keyboard, voice recognition module, audio input/output, or a combination of these or other known input/output devices. Input/output device 140 may consist of one or more large-format touch-screen displays, which may be installed or mounted in portrait or landscape orientations, as preferred based on the system and user-interface design. The device 105 may further interface with external devices, such as a specialized computer 145, a general-purpose computer, a content management system 150, or one or more remote servers and/or databases 155. As would be understood by those of ordinary skill in the art having the present disclosure before them, these and other connections between components of the system (whether physical or virtual) may be via the Internet or other known interconnections.

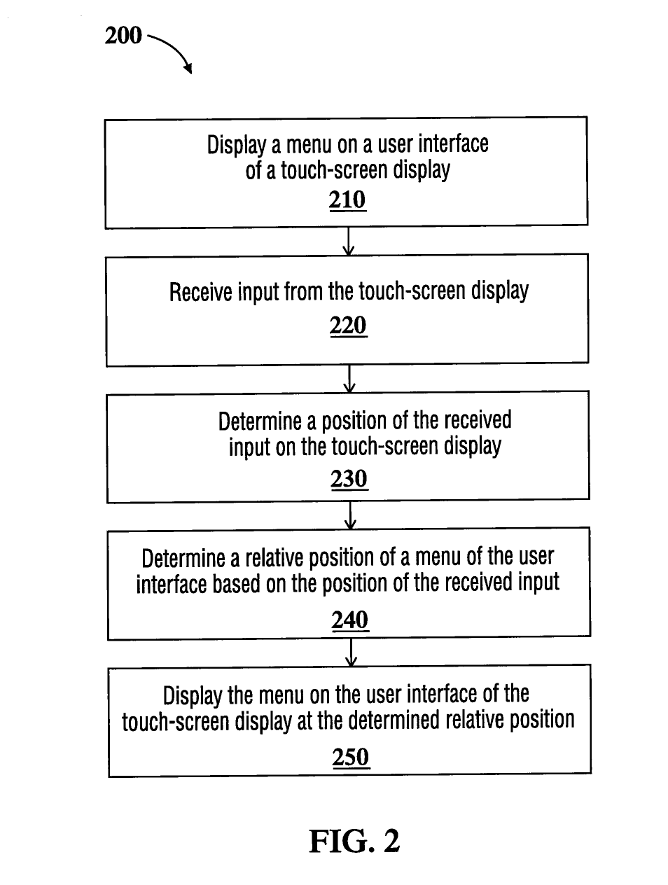

FIG. 2 illustrates an example implementation of a preferred method 200 for providing information to a user in accordance with the subject technology. It will be understood by those of ordinary skill in the art having the present disclosure before them that any specific order or hierarchy of steps in the process 200 is an illustration of one example implementation. It will also be understood by those of ordinary skill in the art having the present disclosure before them that the specific order or hierarchy of steps in the process 200 may be rearranged, and that certain enumerated steps may be omitted or additional known steps performed. The process 200 may begin with step 210 in which a menu is displayed on a user interface of a touch-screen display. Other items such as maps, advertisements, walking routes, event information, or welcome messages may be displayed behind or with the menu on the touch-screen display. In one implementation, the menu and/or the other items may be initially displayed at a predetermined position on the touch-screen display.

In step 220, a user input is received by the processor from the touch-screen display. The input may be received in the form of, for example, a user touching or tapping the touch-screen display, providing a voice command (in an embodiment having voice recognition capabilities), or providing a bar, QR, or other code for scanning by the device 105. The input provides an electronic signal to be interpreted by the processor 120 establishing the position of the input. The user may additionally or alternatively use a stylus, keyboard, or mouse to provide an input to the system. The user may provide input through a voice or audio signal where the system has an audio recognition module. Received input for determining the position on the display screen of information such as the menu can occur at a variety of times during a user's interaction with the wayfinder system. The received input may constitute a user's first interaction with the display. Accordingly, step 210 may occur following step 220. For example, a welcome screen without a menu may be initially displayed on the touch-screen display at a predetermined position, asking the user to touch the screen for a menu of options.

In step 230 the position of the received input on the touch-screen display is determined by the processor. The input may be determined as a vertical position and/or a horizontal position. The position of the input is determined as a comfortable and/or easily accessible position for the user to conduct his interaction with the wayfinder system.

In step 240, a relative position of a menu of the user interface may be determined based on the position of the received input, and in step 250, the menu on the user interface of the touch-screen display is adjusted to be displayed at the determined relative position. The adjustment of the relative position of the menu may occur dynamically, allowing the user to provide additional input by touching or dragging to further adjust the relative position of the menu to the user's preferred position. The adjustments may include a vertical adjustment, a horizontal adjustment, or both. The adjusted relative position of the menu may be located anywhere on the touch-screen display. In a vertical adjustment, the menu's vertical position on the display screen is determined to be at the relative vertical height (or some predetermined distance from the vertical height) at which the initial input is received. For example, if the initial touch occurs approximately one third from the bottom of the touch-screen display, the position of the menu may be adjusted to approximately one third from the bottom of the touch-screen display.

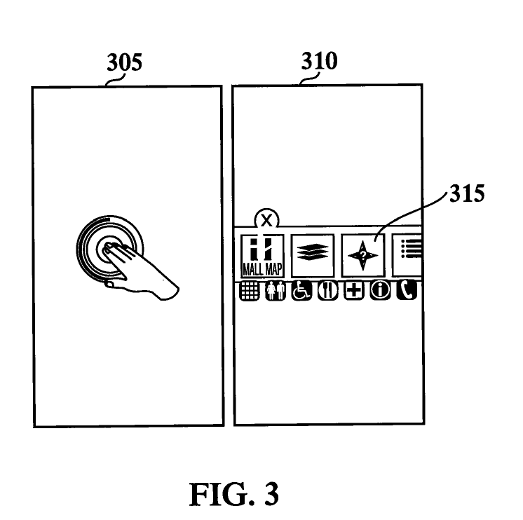

The menu may cover the entire touch-screen display from left to right as shown by menu 310 in FIG. 3. In a horizontal adjustment, portions of the menu may wrap around such that the menu is displayed in only a portion of the touch-screen display from left to right based on the position of the received input. As a user interacts with the menu, the user may make selections or use common navigational gestures such as sliding the menu to the left or right as applicable to reveal the wrapped portion that cause additional menus or portions of the menus to be displayed. The display of additional menus can be dynamically positioned on the touch-screen display similarly to the position of the adjusted menu, providing the benefit of continued user interaction that is at a comfortable position for the user to access the relevant content on the touch-screen display. The menu or other content may include, for example, a virtual keyboard that allows the user to type on the touch-screen display. The virtual keyboard may be located in the user interface of the touch-screen display at the adjusted position of the menu and may be shown or hidden as elected by the user based on need or preference.

FIG. 3 illustrates a system and method of interacting with the device in accordance with the subject technology. The user may begin an interaction with the wayfinder system 100 by touching or tapping 305 the touch-screen display of the wayfinder device 105. The initial touch or tap of the screen 305 may be used to determine the position of the menu in the user interface of the touch-screen display based on the position of the received input, as explained above with respect to FIG. 2. A menu may then be displayed as shown in 310. The position of the menu is determined based on the position of the received user input, i.e., the position on the screen that the user touches or taps the screen. As illustrated, the vertical placement of the menu may be determined based on the vertical position of the initial touch or tap of the screen 305.

The menu 315 may first be displayed on the screen prior to the initial touch or tap of the screen 305 or following the determination of the position of the initial tap. The initial touch or tap of the screen 305 can constitute received input from the touch-screen display. If the menu is displayed on the screen before the initial touch or tap of the screen then the position of the menu may then be adjusted on the basis of the position of the received input from the touch-screen display. Additionally or alternatively, any other content, information, or menus may be displayed prior to or following the initial touch or tap of the screen including, but not limited to, a welcome screen, a map, a listing of business information, an advertisement, a menu, and a message screen requesting the user to tap the screen to reveal a menu. Any image, video or other known content may be displayed as an overlay over the menu, or an underlay behind the menu. The menu may appear on top of other content or may appear integrated along with other information in the background. Any number of design choices or variations of menu items are possible for the display of content and information on the screen.

The determination of the position of the menu need not occur only upon the initial interaction with the wayfinder system 100. The menu 315 may contain an icon that the user may interact with prior to touching or tapping the touch-screen display for the purpose of adjusting the position of the menu manually.

The menu may be used to quickly access information relating to the site or venue where the wayfinder device 105 is located, such as a museum, a mall, a sports stadium, a hospital, or any other venue. The menu 315 may also be used to obtain immediate emergency assistance. The menu 315 may be made available at any time in the process of a user's interaction with the wayfinder system 100. The menu 315 may be customizable based for example on the type of venue or the brand owner, and may include a variety of menu options including search, location, directory, or search information. The menu may include icons representing restrooms, locations of shops or restaurants, handicapped accessible routes and areas, a search engine, directory information, or other types of information, which icons may then be shown or the applicable maps to indicate their respective locations at the site or venue. Any given menu may be an initial default menu that begins each new user session, or may be a menu or other content (e.g., an electronic “Welcome” banner that appears when resetting the user session).

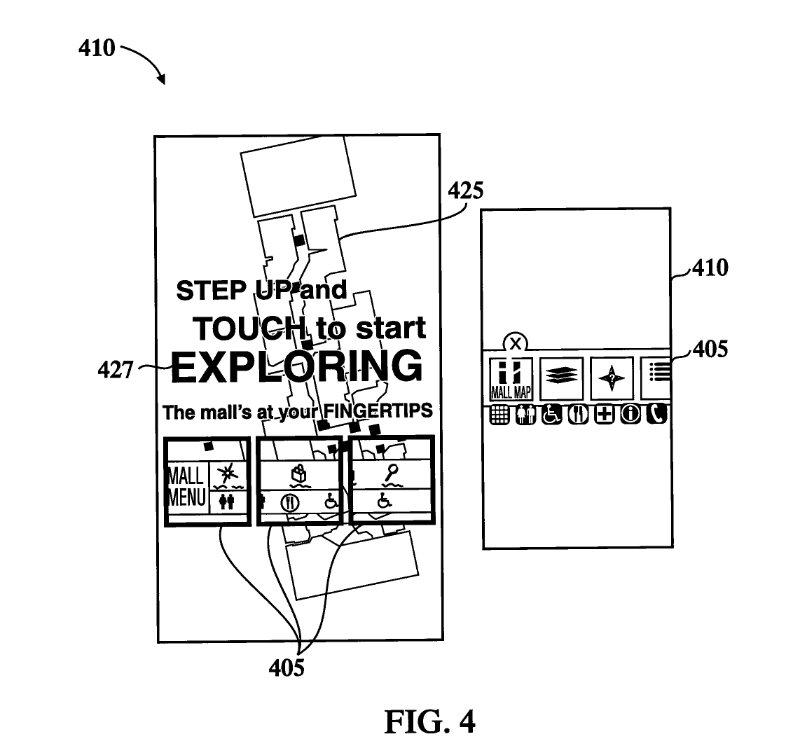

FIG. 4 illustrates two examples of the menu 405 on touch-screen display 410 for providing information in accordance with the subject technology. By default, the menu 405 may be launched at a position central to the activating touch area of the touch screen display 410. The menu 405 may be displayed on a touch-screen display 410 with no other content displayed. Alternatively, menu 405 may be displayed along with additional information such as a map 425 and/or a message 427. Components 405, 425, and 427 may each include video, animations, audio, or a combination. For example, message 427 may change or move on the screen and may include a transparent or semi-transparent background. The menu 405 may allow users to have an on-screen menu with the content they are navigating underneath (such as map 425 and/or message 427) until the menu is closed. The menu may stay on top of the content until it is closed out manually by tapping the “X” icon, or may be automatically hidden after a predetermined period of inactivity. The user may choose to interact with map 425, message 427, or menu 405 at any time.

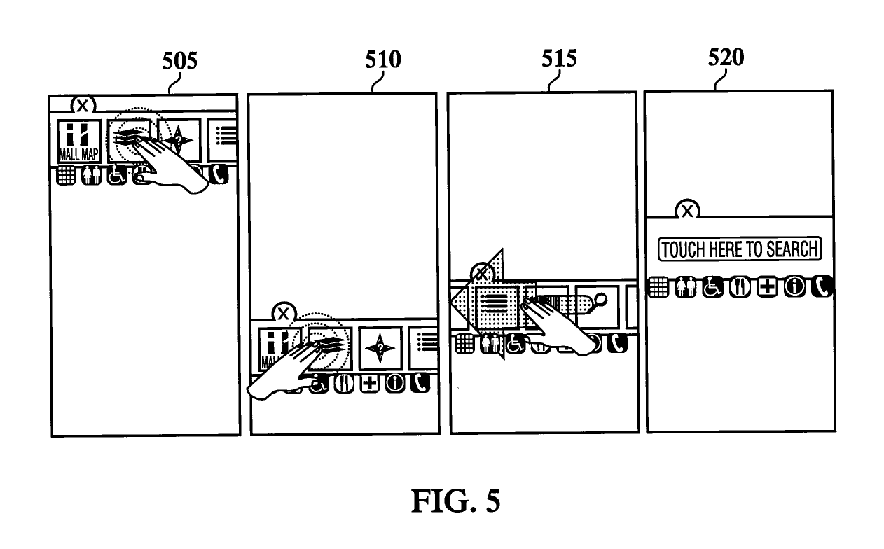

FIG. 5 is a series of display screen shots illustrating how a user can initiate and interact with the menu in accordance with the subject technology. As shown, the positions of the menu on the display may be determined based on the location of the user's touch commands. Example displays 505, 510, and 515 illustrate a few of the many positions in which the menu may be displayed so as to provide a comfortable interactive experience for the user. For example, in 505, a user who is tall may choose to touch the screen at a location that is in the upper area of the display, causing the menu to be adjusted to a position on the screen that is towards the top of the display screen. A search bar may also be provided that extends from the menu. In addition to changing the position of the menu upon initially interacting with the menu, the menu may also may be moved to another position on the touch-screen display corresponding to input provided by the user at any time the menu is active. The menu may include an option for searching 520. The option for searching may also be included on subsequent menus.

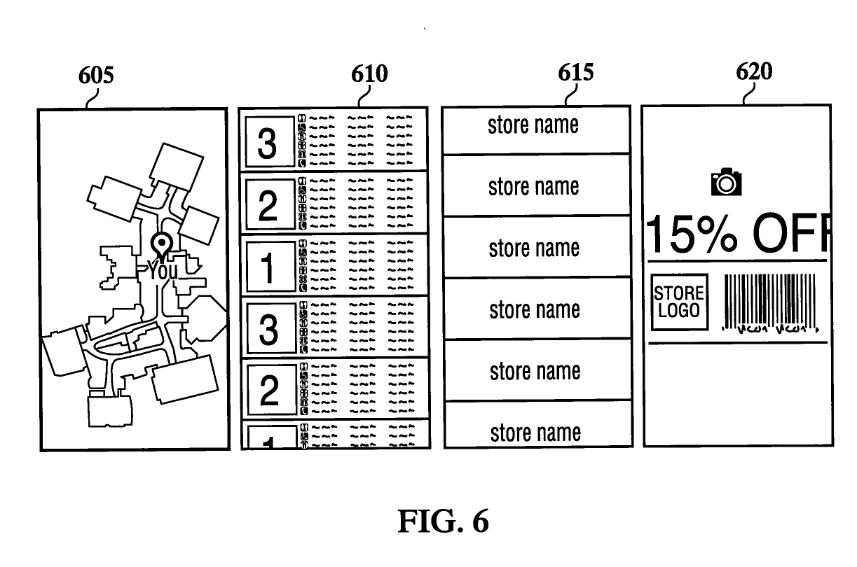

FIG. 6 is a series of display screen shots illustrating a process by which a user can identify businesses and locate discounts in accordance with the subject technology. Through use of the menu and subsequent menus, users may obtain maps of the immediate area. In one example, multiple wayfinder devices 105 are associated with the wayfinder system 100 and may be located at multiple different locations within in a shopping mall or other venue. Users may obtain a map that is a detailed and accurate floor plan 605. A user may interact with the map using common navigational gestures such as dragging, zooming, and the like. A “YOU” icon may be provided to assist the user in orienting herself in her immediate area. A menu may have an icon to lead directly to a map of the immediate area, indicating the user as an icon on the map. Maps may include multilevel floor view and indicate business, restrooms, or other details regarding the surrounding area. A directory listing 610 of all available businesses or resources at the site, venue, immediate area, on the selected floor, or in some other designated location or area may also be provided. Additional listings 615 may be available sorted by category, alphabetically, distance, popularity or other known basis for sorting information. Categories may include stores in the area, restrooms, elevators, information desks, and the like. If a user selects a particular business entity from a listing 610 or 615, or selects a business from a map display 605, a promotional item may be displayed. A promotional item may include, for example, one or more of an advertisement, coupon, incentive, free gift, or other offer or promotion. Preferably, the discounts are barcode based (or other known coding systems, such as bokode or QR code) so the user may capture the image displayed on the touch-screen display with a user device such as a mobile phone or digital camera. Users may then present the image on their user device at the point of sale in order to redeem the coupon, incentive, or other offer.

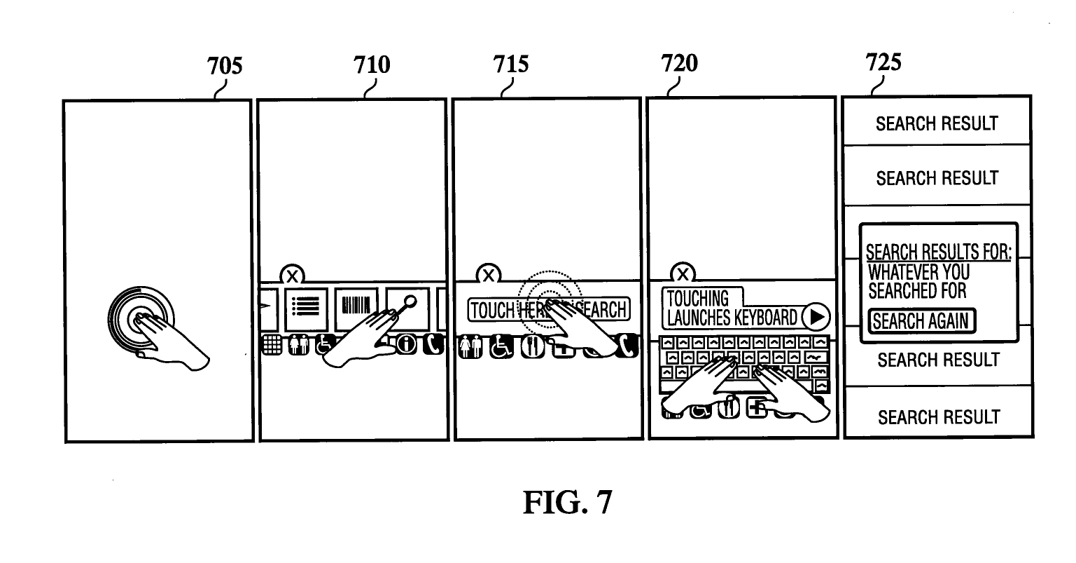

FIG. 7 is a series of display screen shots illustrating one example of the search functionality in accordance with one implementation of the subject technology. When accessing the wayfinder system 100, touching a specified area of the screen or holding a user's hand down on the screen may launches the main menu (i.e., menu). Selecting a search icon then brings up a text field. If the user touches the text field, it launches a keyboard which enables a user to type in a search request. A table of search results may then be displayed. As shown in FIG. 7, an initial tap 705 establishes the position of the menu with respect to the user interface of the touch-screen display 710. The received input of the tap determines the position of the menu that is then displayed to the user in 710. The user may continue to navigate through additional menus that may include options such as a search engine 715. Upon activation of a search engine or other appropriate screen, a virtual keyboard 720 may appear as a portion of the menu on the touch-screen display. As shown in the figure, subsequent interactions may continue at the relative position on the touch-screen display on the basis of the height or position of the initial input by the user with the touch-screen display. Results of the search 725 may then be displayed using all or part of the touch-screen display. Search results may be presented so that the user may move the results of the list up and down for ease of reading.

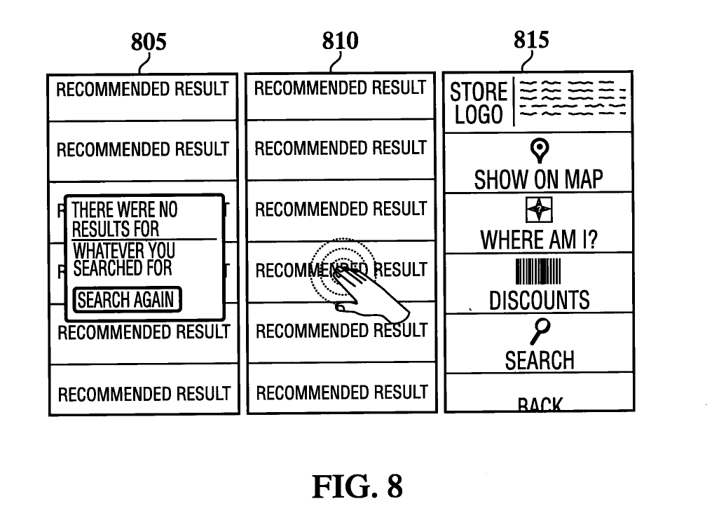

FIG. 8 illustrates a series of recommended results that may be provided if the search described with respect to FIG. 7 fails. For instance, should the search fail 805, recommended results would be shown 810. This helps with common misspellings and other typical human errors. After making a selection from the results, whether recommended or from a regular query, a single press or “tap” launches a detail screen 815. The detail screen provides a full description of the selected result, which may include an image relevant to the selection, location, discounts, and the like. By scrolling vertically, the user may comfortably look through the available results.

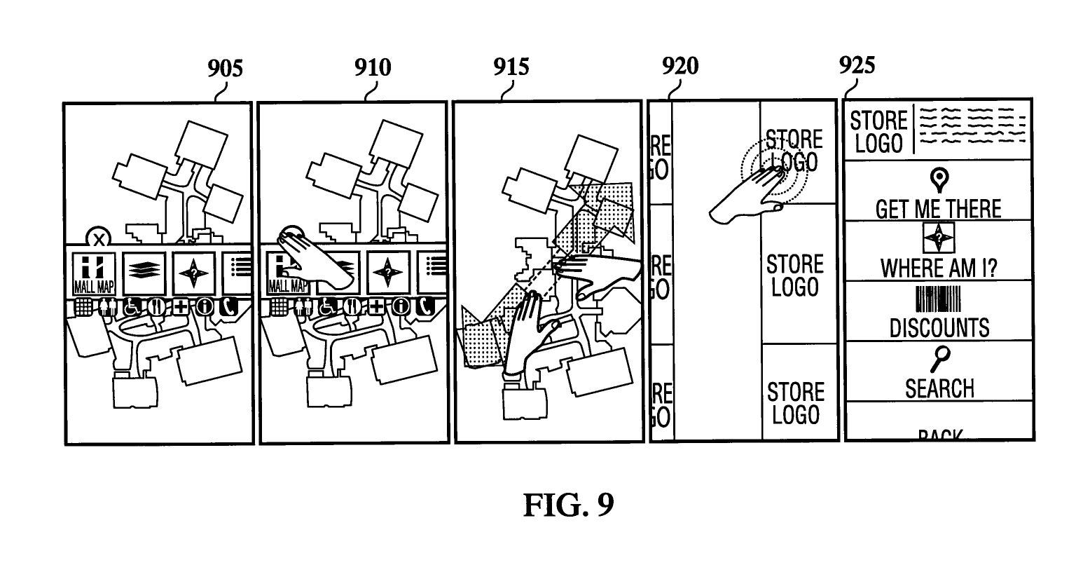

FIG. 9 illustrates an exemplary system and method for providing a map interface in accordance with the subject technology for a series of interfaces enabling a user to browse a map. For instance, a user may browse the map and select a store or other business. The default start view of the wayfinder device 105 may include a map overlaid by the menu 905. The user may close the menu 910 and directly interact with the map. If the details of the map are too small, the user can “pull” or enlarge a portion of the displayed content with a multi-touch gesture using both hands 915. As the zoom level increases with the map 920, the user can continue to interact with the map. The user may select a store logo to obtain additional options associated with the store 925. The user can select “GET ME THERE” and the wayfinder system 100 will draw or otherwise identify a route on the device 105 based on the current location. Alternatively, the route may be orally stated through speakers in the device 105.

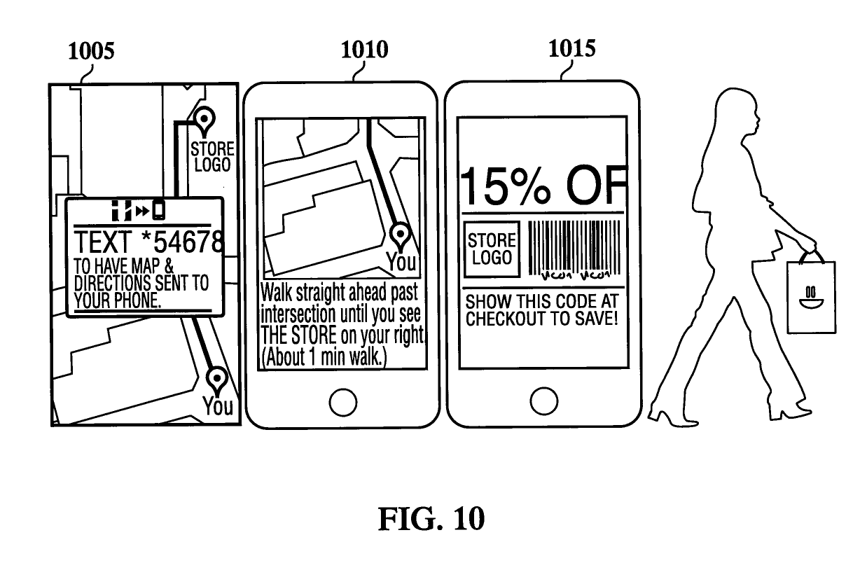

FIG. 10 illustrates a method for providing rewards or incentives in accordance with the subject technology. If the user has, for example, selected an option to obtain a route to a particular location (for example, following the process described in FIG. 9), the user may interact with the wayfinder system 100 to obtain a personal copy of the route. The user may then obtain maps and/or routes for a personal user device from the wayfinder system. For instance, an alert may allow for SMS or text-based interaction, which may supported by the user's mobile device. In one example, the display screen of the wayfinder device may show a map of the obtained route and/or a listed set of directions including information so that the user may obtain a copy of the displayed information on the user's personal device 1005 via SMS text or email. One method of obtaining the information may be for the user to text a displayed number to have the map and instructions sent to the user's personal device via SMS text or email. A user may also enter an e-mail address into the wayfinder device 105. The message is received on the user's mobile device and shows the map and the text based instructions using landmarks and simple language 1010. In one implementation, the a promotional item 1015 may be provided immediately or as a follow up to the user. In the event a user provides his or her email or cell phone number and opts in to receiving marketing and promotional materials, the user's initial interaction with the wayfinder system 100 has the advantage of providing for ongoing marketing and promotional opportunities for brands and/or the venue where the device 105 is located. This process of sending information to the user's personal device may be employed to obtain rewards or any other content relating to information displayed or provided to the user via the wayfinder device 105.

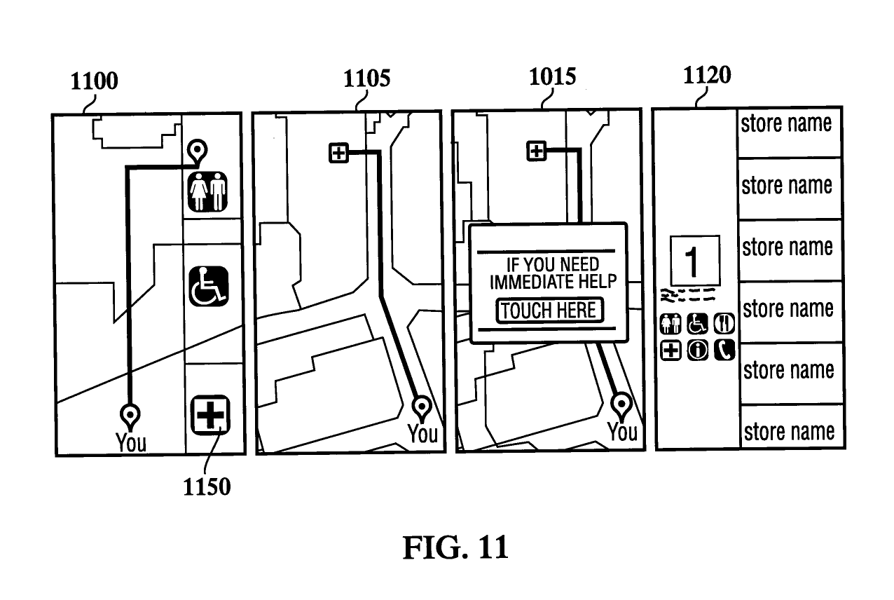

FIG. 11 illustrates an exemplary system and method for providing emergency assistance in accordance with the subject technology. The wayfinder system 100 may additionally provide immediate emergency assistance by sending an alert to emergency services such as paramedics, security, police, or fire department if the user inputs an emergency alert or signal 1115 as per instructions provided on the wayfinder device 105. A user may navigate to an emergency assistance screen 1115 from any menu or display of content on the wayfinder device by selecting an emergency icon 1150. Preferably, the emergency feature is simple enough for use by children in the event a child is separated from his or her guardian, and may be understandable through pictures or icons so that individuals that do not speak the local language proficiently are able to obtain emergency services easily. In one example, the user may select emergency icon 1150 as a destination in a map menu 1100. The wayfinder device may then display a map and route to a first aid station, security office, or other emergency location 1105. The emergency assistance screen 1115 may then be provided to the user to allow the user to request immediate assistance. The user may then interact with the emergency assistance screen 1115 or continue browsing through other menus 1120 of the wayfinder device 105.

Further advantages and modifications of the above described system and method will readily occur to those skilled in the art. The disclosure, in its broader aspects, is not limited to the specific details, representative system and methods, and illustrative examples shown and described above. Various modifications and variations can be made to the above specification without departing from the scope or spirit of the present disclosure, and it is intended that the present disclosure cover all such modifications and variations provided they come within the scope of the following claims and their equivalents.

What is claimed is:

1. A system for providing information, the system comprising:
a display screen having a user interface;
an input device operatively connected to the display screen;
a processor configured to receive one or more inputs from the input device; and
a memory containing processor-executable instructions that, when executed by the processor, cause the system to
receive an input from the input device,
determine a relative position on the display screen at which to display user content based on the received input, and
display the user content at the determined relative position.

2. The system of claim 1, wherein the relative position of the user content includes a relative vertical position, a relative horizontal position, or both.

3. The system of claim 2, wherein a layout of the user content is reconfigured based on the relative horizontal position.

4. The system of claim 1, wherein the user content comprises one or more menus.

5. The system of claim 1, wherein the user interface is configured to display a virtual keyboard in the user interface at the determined relative position.

6. The system of claim 1, the user interface further being configured to display a coupon associated with a business.

7. The system of claim 6, wherein the displayed coupon includes a code that is capable of being scanned.

8. The system of claim 1, the memory further comprising instructions to provide a route to a destination on the user interface and send the route to a user device.

9. The system of claim 1, the memory further comprising instructions to provide a display of a map.

10. A method of providing information, the method comprising:
displaying a menu on a user interface of a touch-screen display at a predetermined position;
receiving an input from the touch-screen display;
determining a position of the received input on the touch-screen display;
determining a relative position of a menu of the user interface based on the position of the received input; and
adjusting the position of the menu on the user interface of the touch-screen display to be displayed at the determined relative position.

11. The method of claim 10, wherein the menu includes an icon for emergency assistance and the method further comprises sending a notification to an emergency service requesting assistance when an icon for emergency assistance is selected.

12. The method of claim 10, the method further comprising
displaying a virtual keyboard in the user interface at the determined relative position of the menu.

13. The method of claim 10, the method further comprising
displaying a promotional item associated with a business.

14. The method of claim 13, the display of a promotional item including a code that is capable of being scanned.

15. The method of claim 10, the method further comprising
displaying a route to a destination; and
sending the route to a user device.

16. The method of claim 10, the method further comprising:
receiving a second input from the touch-screen display;
determining a second position of the received second input on the touch-screen display;
determining a second relative position of a menu of the user interface based on the position of the received input; and
readjusting the position of the menu on the user interface of the touch-screen display to be displayed at the determined second relative position.

17. A system for providing information, the system comprising:
a touch-screen display configured to display one or more menus;
a processor for receiving inputs from the touch-screen display; and
a memory containing processor-executable instructions that, when executed by the processor, cause the system to:
display a menu on the user interface of the touch-screen display at a predetermine position,
receive an input from the touch-screen display,
determine a position of the input on the touch-screen display,
adjust the relative position of the menu in the user interface of the touch-screen display based on the position of received input; and
display promotional content corresponding to a user selection, wherein the promotional content includes an electronically readable code.

18. The system of claim 17, wherein the adjusted relative position of the menu includes a vertical relative position, a horizontal relative position, or both.

19. The system of claim 18, wherein a layout of the menu is reconfigured based on the relative horizontal adjustment.

20. The system of claim 17, wherein a plurality of menus are provided at the adjusted relative position of the menu.
